(19) United States
(12) Patent Application Publication
(10) Pub. No.: US 2004/0261221 A1
(43) Pub. Date: Dec. 30, 2004

(54) Handle for holding and securing telescoping tubings

(76) Inventor: Marc Dumont, Delson (CA)

Correspondence Address: INVENTARIUM, SUITE 1607, 4050 ROSEMONT BLVD, MONTREAL, QC, H1X2M4, CA

(21) Appl. No.: 10/856,243

(22) Filed: May 28, 2004

Related U.S. Application Data
(60) Provisional application No. 60/477,066, filed on Jun. 10, 2003.

(51) Int. Cl. E05B 1/00

(52) U.S. Cl. 16/110.1

(57) ABSTRACT

A handle for holding and securing telescoping tubings has a handle which when turned, partially threads in or threads out a threaded knob. According to which direction the handle is turned, it causes a block to either become tighter when the threaded knob is threaded in or looser when the threaded knob is threaded out. This either pushes the inner tubing towards the opposite faces of an outer tubing when threading in and increase the friction between the inner and the outer tubing or reduce the friction between the inner tubing and the outer tubing by loosening the block when threading out.

This application claims priority based on provisional application 60/477,066 filed Jun. 10, 2003 HANDLE FOR HOLDING AND SECURING TELESCOPING TUBINGS

### BACKGROUND OF THE INVENTION

1. Field of the Invention

The invention relates generally to pins but more particularly to spring loaded pins used for retaining two slidably engaging elements, generally telescoping square steel tubings.

2. Background of the Invention

Retainer pins come in many sizes and configurations and are used for holding or retaining various sliding elements used on a variety of products. More commonly, these sliding elements are used on exercise training machines to quickly adjust the machine to the requirements of the user. Of course, training equipment is far from the only field where retainer pins are utilized.

When retainer pins are used to hold two slidingly engaging elements such as telescopically engaged square steel tubings, in order for the said elements to reduce friction between them when they slide against one another, a space is maintained between the said sliding elements. The problem with having a spacing is that, although the elements are maintained in a certain relative position with the insertion of the retainer pin which, typically, passes through both sliding elements by way of two holes which are in alignment, the two slidable elements are allowed to shake or wiggle somewhat. In a lot of cases, this is of no consequence but in some applications where it can be critical, methods such as makeshift wedges like a piece of wood or folded paper have been used. Another more sophisticated solution comes by way of a threaded pin positioned at the intersection of two faces of an outer square tube and by threading the threaded pin, it actually forces an inner square tube against the opposite faces of the outer tube in order to eliminate any “wiggling”.

Other inventions include a threaded pin on an outer tube which pushes against an inner tube to force friction between both the outer and the inner tube or have the threaded pin push against an element set within a tube so that this element pushes the inner tube against the outer tube when the threaded pin is theaded in.

### SUMMARY OF THE INVENTION

The present invention discloses two variations or embodiments producing substantially similar results using substantially similar means. The variations are described here as two examples of possible variations falling within the scope of a single invention. Both examples provide for a handle which actuates a block piece which acts as the pushing means to push the inner square tube against the opposite faces of the outer square tube with the exception that one embodiment combines a pin with the block. The advantage of the pinless variation is that it eliminates the need for holes on the inner square tube so that it presents a smooth finish. In both embodiments, the faces of the outer tube, by being pushed against the faces of the inner tube create enough friction between the inner and outer tube that they do not slide or move or even wiggle in relation to each other.

It is therefore a main object of this invention to provide for a simple to use system of locking handle that holds and then tightly secures a pair of telescopically and slidably engaged elements such as telescoping square tubings.

The foregoing and other objects, features, and advantages of this invention will become more readily apparent from the following detailed description of a preferred embodiment with reference to the accompanying drawings, wherein embodiments of the invention are shown and described, by way of examples. As will be realized, the invention is capable of other and different embodiments, and its several details are capable of modifications in various obvious respects, all without departing from the scope of the invention. Accordingly, the drawings and description are to be regarded as illustrative in nature, and not as restrictive.

### BRIEF DESCRIPTION OF THE PREFERRED EMBODIMENT

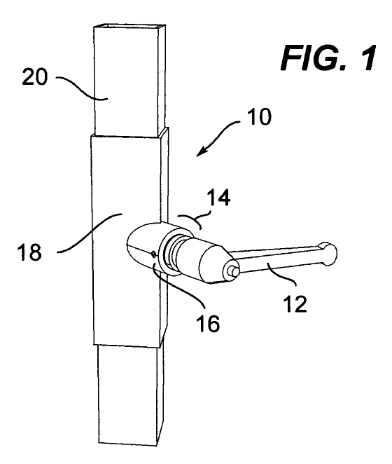

FIG. 1 Is an isometric view of the pinless version of the device.

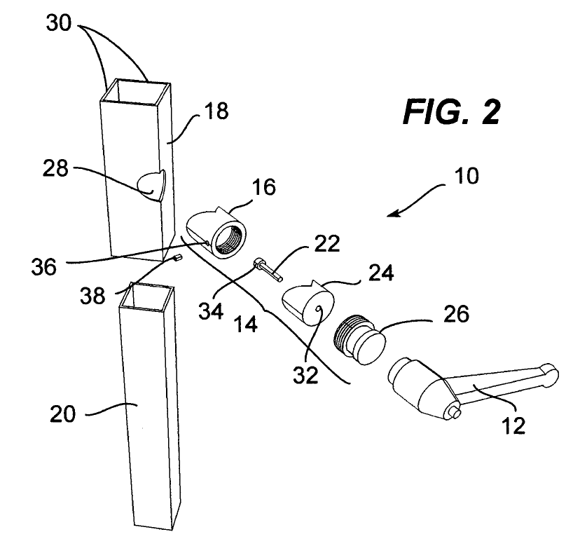

FIG. 2 Is an exploded perspective view of the pinless version of the device.

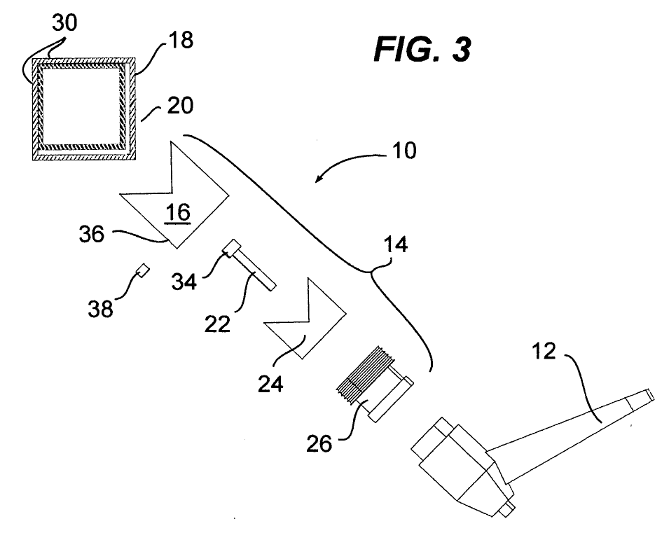

FIG. 3 Is a top exploded view of the pinless version of the device.

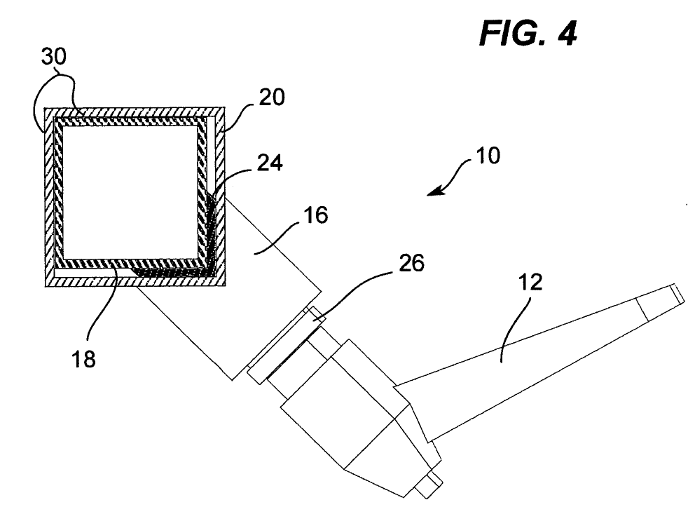

FIG. 4 Is a top view of the pinless version of the device.

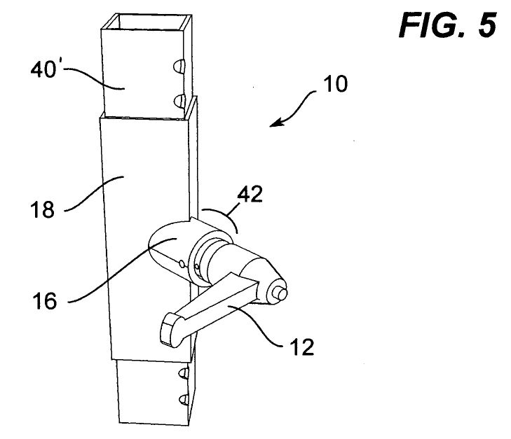

FIG. 5 Is an isometric view of the pin version of the device.

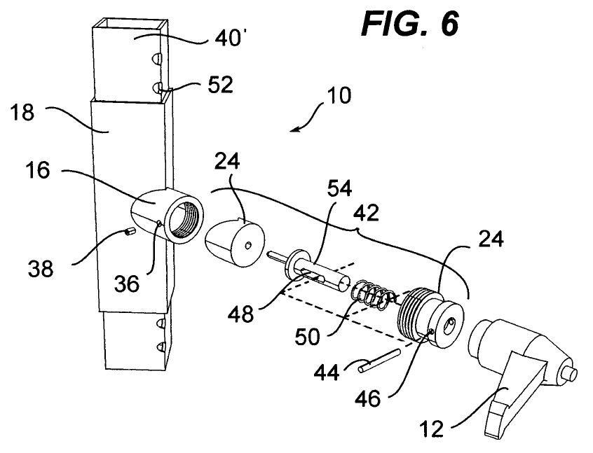

FIG. 6 Is an exploded perspective view of the pin version of the device.

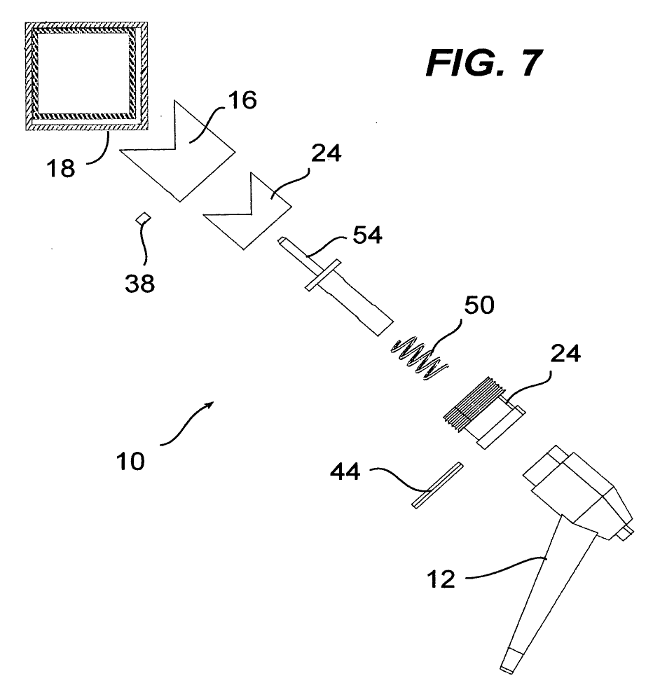

FIG. 7 Is a top exploded view of the pin version of the device.

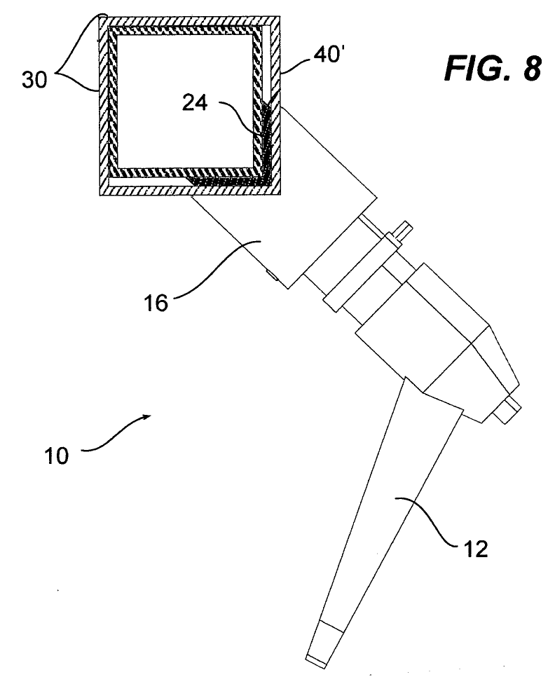

FIG. 8 Is a top view of the pin version of the device.

### DETAILED DESCRIPTION OF THE PREFERRED EMBODIMENT

Referring to FIG. 1, a handle for holding and securing telescoping tubings (10) has a handle (12) rotationally connected to a handle mount (14). The handle mount (14) has a cover (16) which is fixedly attached to an outer tubing (18), the latter enveloping an inner tubing (20). FIGS. 2-4 show in more detail the various components which include the handle (12) and the components of the handle mount (14) including the cover (16) a pin (22) a block (24) and a threaded knob (26). The outer tubing (18) has an opening (28) through which can pass the block (24) in order to push the inner tubing (20) against the opposite faces (30) of the outer tubing (18). Turning the handle (12), which is fixedly attached to the threaded knob (26), partially threads in or threads out the threaded knob (26) seen in FIG. 3 according to which direction the handle (12) is turned, which causes the block (24) to either become tighter when the threaded knob (26) is threaded in or looser when the threaded knob (26) is threaded out. This will either push the inner tubing (18) towards the opposite faces (30) when threading in and increase the friction, or reduce the friction between the inner tubing (20) and the outer tubing (18) by loosening the block (24) when threading out. The pin (22) has a pin head (34) and passes through a block hole (32) in the block (24) and attaches to the threaded knob (26). The function of the pin (22) and its pinhead (34) is to hold the block (24) securedly so that it won't fall off, should a user inadvertently unscrew the handle (12) too much or any such use which would expose the block (24). At the side of the cover (16) is a threaded hole (36) through which is inserted a screw (38) which secures the knob (26) in place within the cover (16).

FIGS. 5-8 present a variation which has a perforated inner tubing (40′) and a more complex handle mount (42). This variation has a dowel (44) that is inserted into a passthrough hole (46), through an insertion pin slot (48) to limit the movement of an insertion pin (54). The dowel also serves to confine the range of motion of a biasing means (50). Pulling on the handle (12) pulls on the insertion pin (54) which is liberated from any one hole (52) from the perforated inner tubing (40′) so that the outer tubing (18) can be moved. The biasing means (50) pushes the insertion pin (54) so that it will engage into any of the holes (52) it encounters as long as the handle (12) is released. Turning the handle (12) will have the same effect in both variations, that is to act upon the block (24). This embodiment is very efficient when supporting heavy loads is important but with the drawback that adjustmnet is limited to the positions of the holes (52).

1. A handle for holding and securing telescoping tubings wherein an outer tubing slides over an inner tubing and comprising:
a handle rotationally connected to a handle mount;
said handle mount having a cover fixedly attached to said outer tubing;
a threaded knob fixedly attached to said handle;
said threaded knob pushing a block;
said block allowed passage through an opening in said outer tubing so as to push said inner tubing against the opposite faces of said outer tubing.

2. A handle for holding and securing telescoping tubings as in claim 1 except that a perforated inner tubing replaces the inner tubing and wherein:
a dowel is inserted into a passthrough hole through an insertion pin slot to limit the movement of an insertion pin;
said dowel confining the range of motion of a biasing means;
said insertion pin engaging any one of a plurality of holes situated on said perforated inner tubing.

3. A handle for holding and securing telescoping tubings as in claim 2 wherein:
pulling on said handle pulls on said insertion pin so as to remove it from any one hole from said perforated inner tubing so that said outer tubing can be moved;
said biasing means pushing said insertion pin so that it engages into any of said holes it encounters as long as said handle is released.

4. A handle for holding and securing telescoping tubings having the following method of use:
turning said handle partially threads in or threads out a threaded knob according to which direction said handle is turned, which causes a block to either become tighter when said threaded knob is threaded in or looser when said threaded knob is threaded out;
turning said handle partially threads in or threads out said threaded knob which pushes an inner tubing towards the opposite faces of an outer tubing when threading in and increases the friction or reduce the friction between said inner tubing and said outer tubing by loosening said block when threading out.

5. A handle for holding and securing telescoping tubings as in claim 1 wherein:
said block being retained to said threaded knob by way of a pin.

6. A handle for holding and securing telescoping tubings as in claim 5 wherein:
said pin having a pin head and said pin passing through a block hole in said block and attaching to said threaded knob so as to securedly hold said block.

7. A handle for holding and securing telescoping tubings as in claim 1 wherein:
a threaded hole situated at the side of said cover having a screw inserted therein and said screw securing said knob in place within said cover.
